(19) United States
(12) Patent Application Publication
(10) Pub. No.: US 2017/0141681 A1
(43) Pub. Date: May 18, 2017

(54) CHARGE PUMP AND ELECTRONIC DEVICE COMPRISING CHARGE PUMP

(71) Applicant: Capital Microelectronics Co., Ltd., Beijing (CN)

(72) Inventor: Rifeng MAI, Beijing (CN)

(73) Assignee: Capital Microelectronics Co., Ltd., Beijing (CN)

(21) Appl. No.: 14/907,646

(22) PCT Filed: May 6, 2015
(86) PCT No.: PCT/CN2015/078368

§ 371 Date: Jan. 26, 2016

(51) Int. Cl. H02M 3/07

(52) U.S. Cl. CPC H02M 3/07

(57) ABSTRACT

A charge pump circuit includes a first PMOS transistor and a first NMOS transistor that are connected in series to a main charging and discharging circuit, where a grid electrode of the first PMOS transistor is controlled by an inverted signal of a first control signal. A grid electrode of the first NMOS transistor is controlled by a second control signal. The circuit further includes a second PMOS transistor that is located in a first branch circuit, where a grid electrode of the second PMOS transistor is controlled by the first control signal; and includes a second NMOS transistor that is located in a second branch circuit, where a grid electrode of the second NMOS transistor is controlled by an inverted signal of the second control signal. The embodiments resolve a problem of leakage currents.

### BACKGROUND

Technical Field

The present invention relates to electronic devices, and in particular, to a charge pump.

Related Art

Charge pumps, also referred to as switched-capacity voltage converters, are a type of DC-DC converters for energy storage by using a so-called “flying” or “pump” capacitor. They can allow an input voltage to increase or decrease, or can be used to generate a negative voltage. Internal FET switch arrays thereof control charge and discharge of a flying capacity in some manner, so that the input voltage increases or decreases by a certain factor, thereby obtaining a required output voltage. Such a specific modulation process can ensure that the efficiency is up to 80%, and only an external ceramic capacitor is needed.

In existing electronic devices, an MOS transistor is generally used to form a charge pump circuit. However, as a certain degree of leakage current exists in the MOS transistor, the charge pump has a certain leakage current, so that power consumption of the electronic devices is relatively high. Therefore, it is necessary to suppress the current.

### SUMMARY

Embodiments of the present invention provide a charge pump circuit, including a main charging and discharging circuit, where a first PMOS transistor and a first NMOS transistor are mutually connected in series to the main charging and discharging circuit, a grid electrode of the first PMOS transistor is controlled by an inverted signal of a first control signal, and a grid electrode of the first NMOS transistor is controlled by a second control signal; including a first branch circuit, where a second PMOS transistor is located in the first branch circuit, a source electrode of the second PMOS transistor is connected to a source electrode of the first PMOS transistor, and a grid electrode of the second PMOS transistor is controlled by the first control signal; and including a second branch circuit, where a second NMOS transistor is located in the second branch circuit, a source electrode of the second NMOS transistor is connected to a source electrode of the first NMOS transistor, and a grid electrode of the second NMOS transistor is controlled by an inverted signal of the second control signal, where under control of different first control signal and second control signal, a first node at which a drain electrode of the first PMOS transistor and a drain electrode of the first NMOS transistor are located, a second node at which a drain electrode of the second PMOS transistor is located, and a third node at which a drain electrode of the second NMOS transistor is located are maintained at a same voltage or approximate voltages.

Preferably, the charge pump circuit includes 1× buffers, configured to maintain the first node, the second node and the third node at a same voltage.

Preferably, the charge pump circuit includes a third PMOS transistor, a fourth PMOS transistor and a fifth PMOS transistor, where source electrodes of the third PMOS transistor and the fourth PMOS transistor are coupled to a supply voltage, and grid electrodes thereof are controlled by VP; a drain electrode of the third PMOS transistor is connected to the source electrode of the first PMOS transistor; a drain electrode of the fourth PMOS transistor is connected to a source electrode of the fifth PMOS transistor; a grid electrode of the fifth PMOS transistor is coupled to a ground level; and a drain electrode of the fifth PMOS transistor is coupled to the third node.

Preferably, the charge pump circuit includes a third NMOS transistor, a fourth NMOS transistor and a fifth NMOS transistor, where source electrodes of the third NMOS transistor and the fourth NMOS transistor are coupled to a ground voltage, and grid electrodes thereof are controlled by VN; a drain electrode of the third NMOS transistor is connected to the source electrode of MN1; a drain electrode of the fourth NMOS transistor is connected to a source electrode of the fifth NMOS transistor; a grid electrode of the fifth NMOS transistor is coupled to a supply voltage; and a drain electrode of the fifth NMOS transistor is coupled to the second node.

Preferably, the main circuit includes a sixth PMOS transistor (MP23) and a sixth NMOS transistor (MN23), the first branch circuit includes a seventh PMOS transistor (MP24), and the second branch circuit includes a seventh NMOS transistor (MN24), where the sixth PMOS transistor matches the seventh PMOS transistor, and the sixth NMOS transistor matches the seventh NMOS transistor.

The embodiments of the present invention resolve a problem of leakage currents. In addition, at different stages, because voltages between corresponding nodes are the same or substantially the same, no voltage return is needed, thereby resolving a problem of relatively slow return in the prior art.

The charge pump circuit in the embodiments of the present invention may be applied to various electronic devices.

### BRIEF DESCRIPTION OF THE DRAWINGS

FIG. 1 is a schematic diagram of a charge pump circuit according to a first embodiment of the present invention;

FIG. 2 is a state diagram of the charge pump circuit of FIG. 1 when U=1, and D=0;

FIG. 3 is a state diagram of the charge pump circuit of FIG. 1 when U=0, and D=1;

FIG. 4 is a state diagram of the charge pump circuit of FIG. 1 when U=0, and D=0; and

FIG. 5 is a schematic diagram of a charge pump circuit according to a second embodiment of the present invention.

### DETAILED DESCRIPTION

The following further describes technical solutions of the present invention in detail with reference to the accompanying drawings and the embodiments.

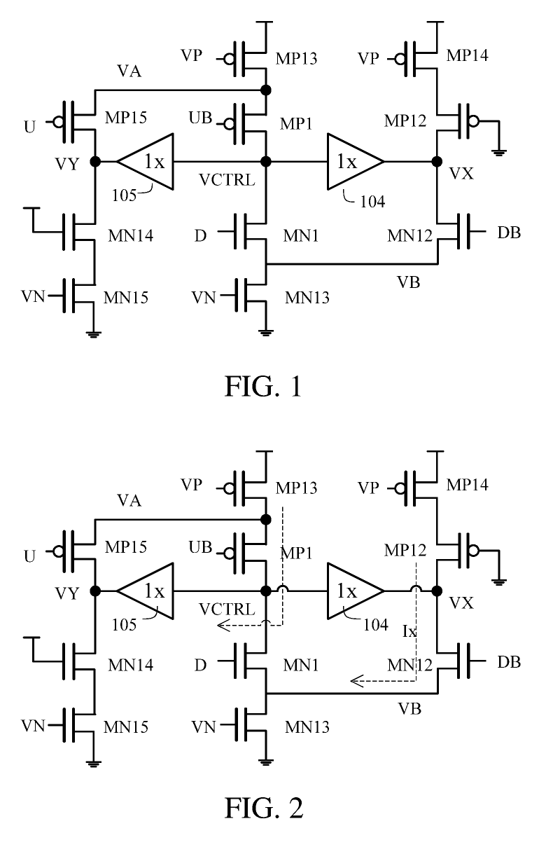

FIG. 1 is a schematic diagram of a charge pump circuit according to a first embodiment of the present invention. As shown in FIG. 1, the charge pump circuit includes a main charging and discharging circuit, where a first PMOS transistor MP1 and a first NMOS transistor MN1 are mutually connected in series to the main charging and discharging circuit, a drain electrode of the MP1 and a source electrode of the MN1 are connected at a node CTRL (marked by a voltage VCTRL), a grid electrode of the MP1 is controlled by an inverted signal UB of a first control signal U, and a grid electrode of the MN1 is controlled by a second control signal D. In an example, the charge pump circuit may include a third PMOS transistor MP13, where a drain electrode of the MP13 is connected to a source electrode of the MP1, a source electrode thereof is coupled to a supply voltage, and a grid electrode thereof is controlled by VP; and may also include a third NMOS transistor MN13, where a drain electrode of the MN13 is connected to the source electrode of the MN1, a source electrode thereof is coupled to a ground level, and a grid electrode thereof is controlled by VN.

The circuit further includes a first branch circuit, where a second PMOS transistor MP15 is connected in series to the first branch circuit, a source electrode of the MP15 is connected to the source electrode of the MP1 through a line A (marked by a line voltage VA), a drain electrode of the MP15 is connected to a node Y (marked by a voltage VY), and a grid electrode of the MP15 is controlled by the U. In an example, the first branch circuit may further be provided with a fourth NMOS transistor MN14 and a fifth NMOS transistor MN15, where a drain electrode of the MN14 is connected to the node Y, a source electrode of the MN14 is connected to a drain electrode of the MN15, a source electrode of the MN15 is coupled to ground, a grid electrode of the MN14 is connected to a high level, and a grid electrode of the MN15 is controlled by the VN.

The circuit further includes a second branch circuit, where a second NMOS transistor MN12 is located in the second branch circuit, a drain electrode of the MN12 is connected to a node X (marked by a voltage VX), a grid electrode thereof is controlled by an inverted signal DB of the second control signal D, and a source electrode of the MN12 is connected to the source electrode of the MN1 through a line B (marked by a voltage VB). The second branch circuit may further include a fourth PMOS transistor MP14 and a fifth PMOS transistor MP12. A drain electrode of the MP14 is connected to a source electrode of the MN12. A grid electrode of the MP14 is controlled by the VP, and a source electrode thereof is coupled to a supply voltage. A grid electrode of the MP12 is grounded, and a drain electrode thereof is coupled to the third node X.

A 1× buffer with an amplification factor of 1 is connected between the node Y and the node CTRL, so that the VY is equal to the VCTRL.

A 1× buffer is connected between the node X and the node CTRL, so that the VX is equal to the VCTRL.

Under control of the first control signal U and the second control signal D, the charge pump performs charging and discharging. The U and D may have different signal combinations. Values of the VP and VN are generally selected so that the MOS transistor is turned on.

When U=1, and D=0 (UB=0, DB=1), the MP1 is turned on, and the MN1 is turned off, a capacitor is charged by using the MP1 through the node CTRL, and the VA is approximately equal to the VCTRL; the MP15 is turned off; the MN12 is turned on, and the VB is approximately equal to the VX; and therefore VA=VB=VX=VY=VCTRL. A current path exists from the node X to the MN12, with a current of ix. Refer to FIG. 2.

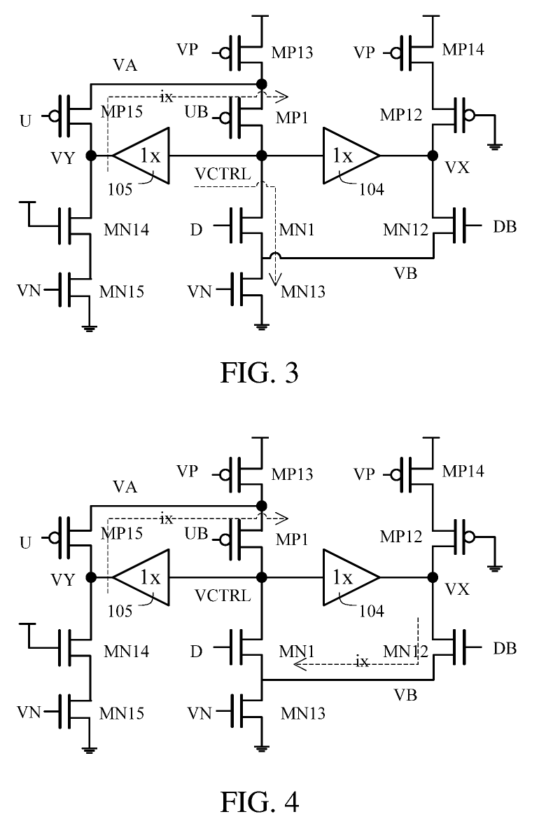

When U=0, and D=1 (UB=1, DB=0), the MP1 is turned off, and the MN1 is turned on, a capacitor is discharged by using the MN1 through the node CTRL, and the VB is approximately equal to the VCTRL; the MP12 is turned off; the MN15 is turned on, and the VA is approximately equal to the VY; and therefore VA=VB=VX=VY=VCTRL. A current path exists from the node Y to the MP15, with a current of ix. Refer to FIG. 3.

When U=0, and D=0 (UB=1, DB=1), the MP1 is turned off, the MN1 is also turned off, and a capacitor cannot be charged through the node CTRL; the MP15 is turned on, and the VA is approximately equal to the VY; the MN12 is turned on, and the VB is approximately equal to the VX; and therefore VA=VB=VX=VY=VCTRL. A current path exists from the node X to the MN12, and another current path exists from the node Y to the MP15, each with a current of ix. Refer to FIG. 4.

In the foregoing procedure, a leakage current is close to 0, and therefore a problem of leakage currents is resolved. In addition, at different stages, the VA and VB are both equal to the VCTRL, and therefore voltage return is not needed, thereby resolving a problem of relatively slow return in the prior art.

Certainly, if the first NMOS transistor in the main charging and discharging circuit matches a circuit part that is in the first branch circuit and far away from the first PMOS transistor, and the first PMOS transistor in the main charging and discharging circuit matches a circuit part that is in the second branch circuit and far away from the first NMOS transistor, the problem of leakage currents can also be effectively resolved to a certain degree.

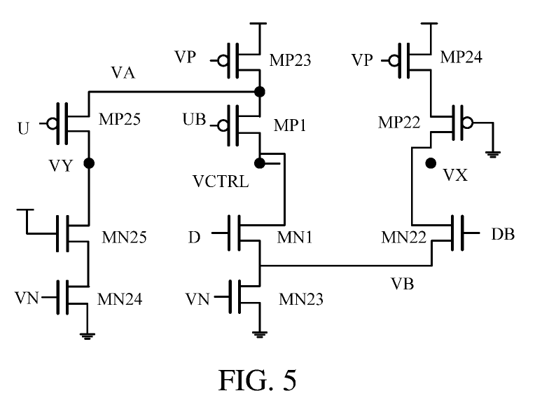

FIG. 5 is a schematic diagram of a circuit according to a second embodiment of the present invention. As shown in FIG. 5, the circuit includes a main charging and discharging circuit, where a PMOS transistor MP1 and an NMOS transistor MN1 are mutually connected in series to the main circuit, a drain electrode of the MP1 is connected to a drain electrode of the MN1, a grid electrode of the MP1 is controlled by UB, and a grid electrode of the MN1 is controlled by D. The main circuit may further have a PMOS transistor MP23 and an NMOS transistor MN23 connected thereto. A grid electrode of the MP23 is controlled by VP, and a grid electrode of the MN23 is controlled by VN.

The circuit further includes a first branch circuit, where a PMOS transistor MP25 is located in the first branch circuit, a source electrode of the MP25 is connected to a source electrode of the MP1, and a grid electrode of the MP25 is controlled by U. The first branch circuit may further be provided with NMOS transistors MN24 and MN25, where a drain electrode of the MN25 is connected to a drain electrode of the MP25, a grid electrode of the MN25 is connected to a high level, a source electrode of the MN25 is connected to a drain electrode of the MN24, a grid electrode of the MN24 is controlled by the VN, and a source electrode of the MN24 is coupled to ground.

The circuit further includes a second branch circuit, where an NMOS transistor MN22 is connected to the second branch circuit, a source electrode of the MN22 is connected to a source electrode of the MN1, and a grid electrode of the MN22 is controlled by DB. The second branch circuit may further be provided with PMOS transistors MP24 and MP22. A source electrode of the MP24 is coupled to a supply voltage, a grid electrode thereof is controlled by the VP, and a drain electrode thereof is connected to a drain electrode of the MP22; while a grid electrode of the MP22 is grounded, and a source electrode of the MN22 is connected to the source electrode of the MN1 through a line B.

A difference from the first embodiment is that, in this embodiment, instead of providing 1× buffers, the MN24 and the MN23 match with each other, while the MP23 and the MP24 also match with each other.

When U=1, and D=0 (UB=0, DB=1), the MP1 is turned on, the MN1 is turned off, a capacitor is charged by using the MP1 through the node CTRL, and the VA is approximately equal to the VCTRL; the MP25 is turned off; the MN22 is turned on, and the VB is approximately equal to the VX; and because the MP23 and the MP 24 match with each other, the VCTRL is approximately equal to the VX, and thus VA=VB=VX=VCTRL. A current path exists from the node X to the MN12, with a current of ix.

When U=0, and D=1 (UB=1, DB=0), the MP1 is turned off, the MN1 is turned on, a capacitor is discharged by using the MN1 through the node CTRL, the VB is approximately equal to the VCTRL; the MN22 is turned off; the MP25 is turned on, and the VA is approximately equal to the VY; and because the MN24 and the MN23 match with each other, the VY is approximately equal to the VCTRL, and thus VA=VB=VY=VCTRL. A current path exists from the node Y to the MP15, with a current of ix.

When U=0, and D=0 (UB=1, DB=1), the MP1 is turned off, the MN1 is also turned off, and a capacitor cannot be charged through the node CTRL; the MP25 is turned on, and the VA is approximately equal to the VY; the MN12 is turned on, and the VB is approximately equal to the VX. Because the MP23 and the MP24 match with each other, and the MN24 matches the MN23, the VX is approximately equal to the VY, and therefore VA=VB=VX=VY. A current path exists from the node X to the MN12, and another current path exists from the node Y to the MP15, but currents thereof are close to 0.

Therefore, not only a problem of leakage currents is resolved, but also a problem of relatively slow return is resolved.

The charge pump of the embodiments of the present invention can be widely applied to electronic circuits including a phase-locked loop.

The foregoing specific implementation manners further describe the objective, technical solutions and advantageous effects of the present invention in detail. It should be understood that the foregoing description merely shows specific implementation manners of the present invention, but is not intended to limit the protection scope of the present invention. Any modification, equivalent replacement or change made within the spirit and principle of the present invention shall all fall within the protection scope of the present invention.

1. A charge pump circuit, comprising:
a main charging and discharging circuit, wherein a first PMOS transistor and a first NMOS transistor are connected in series to the main charging and discharging circuit, a grid electrode of the first PMOS transistor is controlled by an inverted signal of a first control signal, and a grid electrode of the first NMOS transistor is controlled by a second control signal;
a first branch circuit, wherein a second PMOS transistor is located in the first branch circuit, a source electrode of the second PMOS transistor is connected to a source electrode of the first PMOS transistor, and a grid electrode of the second PMOS transistor is controlled by the first control signal; and
a second branch circuit, wherein a second NMOS transistor is located in the second branch circuit, a source electrode of the second NMOS transistor is connected to a source electrode of the first NMOS transistor, and a grid electrode of the second NMOS transistor is controlled by an inverted signal of the second control signal,
wherein under control of the different first control signal and the second control signal, a first node at which a drain electrode of the first PMOS transistor and a drain electrode of the first NMOS transistor are located, a second node at which a drain electrode of the second PMOS transistor is located, and a third node at which a drain electrode of the second NMOS transistor is located are maintained at a same voltage or approximate voltages.

2. The charge pump circuit according to claim 1, further comprising 1× buffers that are connected between the first node and the second node, and between the first node and the third node, and configured to maintain the first node, the second node and the third node at a same voltage.

3. The charge pump circuit according to claim 1, further comprising a third PMOS transistor, a fourth PMOS transistor and a fifth PMOS transistor, wherein source electrodes of the third PMOS transistor and the fourth PMOS transistor are coupled to a supply voltage, and grid electrodes thereof are controlled by a third control signal; a drain electrode of the third PMOS transistor is connected to the source electrode of the first PMOS transistor; a drain electrode of the fourth PMOS transistor is connected to a source electrode of the fifth PMOS transistor; a grid electrode of the fifth PMOS transistor is coupled to a ground level; and a drain electrode of the fifth PMOS transistor is coupled to the third node.

4. The charge pump circuit according to claim 1, further comprising a third NMOS transistor, a fourth NMOS transistor and a fifth NMOS transistor, wherein source electrodes of the fifth third NMOS transistor and the fourth NMOS transistor are coupled to a ground voltage, and grid electrodes thereof are controlled by a fourth control signal; a drain electrode of the third NMOS transistor is connected to the source electrode of the first NMOS transistor; a drain electrode of the fifth NMOS transistor is connected to a source electrode of the fourth NMOS transistor; a grid electrode of the fifth NMOS transistor is coupled to a supply voltage; and a drain electrode of the fifth NMOS transistor is coupled to the second node.

5. The charge pump circuit according to claim 1, wherein the main circuit comprises a sixth PMOS transistor and a six NMOS transistor, the first branch circuit comprises a seventh PMOS transistor, and the second branch circuit comprises a seventh NMOS transistor, wherein the sixth PMOS transistor matches the seventh PMOS transistor, and the sixth NMOS transistor matches the seventh NMOS transistor.

6. An electronic device, comprising the charge pump circuit according to claim 1.

7. An electronic device, comprising the charge pump circuit according to claim 2.

8. An electronic device, comprising the charge pump circuit according to claim 3.

9. An electronic device, comprising the charge pump circuit according to claim 4.

10. An electronic device, comprising the charge pump circuit according to claim 5.
